(19) United States
(12) Patent Application Publication
(10) Pub. No.: US 2013/0143425 A1
(43) Pub. Date: Jun. 6, 2013

(54) CONNECTION ASSEMBLY FOR CLOSING AN ELECTRIC CONTACT

(71) Applicant: Albin Smrke, Domzale (SK)

(72) Inventor: Albin Smrke, Domzale (SK)

(73) Assignee: MSX Technology AG, Stein (CH)

(21) Appl. No.: 13/514,209

(22) PCT Filed: Dec. 7, 2010
(86) PCT No.: PCT/EP10/07426

§ 371 Date: Aug. 2, 2012

(30) Foreign Application Priority Data
Dec. 7, 2009 (DE) 10 2009 056 979.0
May 27, 2010 (DE) 10 2010 021 772.7

(51) Int. Cl. H01R 13/52

(52) U.S. Cl. CPC H01R 13/5213
USPC 439/136

(57) ABSTRACT

The invention relates to a connection assembly (1) for closing an electric contact, comprising a connection part (3) having at least one first electric contact (5, 17) and a movable cover element (6, 15) for covering the contact (5, 17) and a base part (10) that can be connected to the connection part (3) and that has at least one second electric contact (6, 15), wherein the connection part (3) comprises an opening (4, 20) that can be closed by the cover element (6, 15). The cover element (6) is arranged such that, when the connection part (3) is connected to the base part (10), it exposes the opening (4) such that the first contact (5, 17) is connected to the second contact (6, 15) in a conductive manner.

The invention relates to a connection assembly for closing an electric contact, in particular for supplying a cordless electric appliance.

Connection assemblies for cordlessly supplying electric energy to an electric appliance are known in the field of home appliances, especially kettles. Such a connection arrangement is described, for example, in EP 1 679 474 A2. This conventional device includes a connection part provided with at least one electric contact and a base part arranged in the bottom of the kettle having likewise at least one electric contact which can be plugged onto the connection part. The electric contacts in the connection part are protected against external contact by a spring-loaded, displaceable cover element. When the base part is plugged onto the connection part, the cover element can be displaced by a corresponding plug-in element disposed in the base part to unblock the electric contacts.

The connection part of this conventional connection assembly has two coaxial ring-shaped openings and a central opening. These openings are in the closed configuration, when the kitchen appliance is not plugged in, closed by precisely fitting, likewise ring-shaped cover elements, whereas the central opening is closed by a precisely fitting, pin-shaped cover element. The current-carrying contacts in the connection part are then covered, as long as the kitchen unit is not plugged onto the connection part. At the same time, the contacts are protected from dirt and penetration of liquids. However, an operator may still be able to accidentally come into contact with the domestic power grid, when the ring-shaped cover elements or the pin-shaped cover element are displaced by a corresponding needle-shaped or lamella-shaped metal object so far that a contact is formed with the inner, current-carrying contact elements.

Based on this concept, it is an object of the invention to provide a connection assembly for closing an electric contact, in particular for supplying electric energy to devices, which prevents accidental and potentially dangerous access by a person to the electric contacts of the device or makes such access at least significantly more difficult.

The object is solved in that at least one closable opening is arranged in the connection part which can be closed with the displaceable cover element. A contact connected with a power source is arranged in the area of this opening, which after the opening is unblocked, i.e. after the displaceable cover element is displaced, establishes a conductive connection with the corresponding contact in the base part.

Consistent with the above-mentioned prior art, although the cover is displaced when the base part is plugged onto the connection part, in contrast to the aforementioned prior art, at least one opening is unblocked through which the at least one contact in the connection part contacts the at least one corresponding contact in the base part. The cover cannot be displaced (removed) from the opening, nor can a metal object be inserted, which could cause an accidental and dangerous contact of a person with the power source. Contact with parts under current is prevented even if the cover were displaced with a metal object.

Preferably, the at least one contact arranged in the area of the at least one opening may be formed so as to be radially resilient and automatically spring back when the kitchen appliance is lifted from the connection part.

The at least one contact disposed on or in the inner side wall of the base part may be arranged as a continuous or segmented contact ring at the height of the at least one opening in the connection part, so that the electric device (such as a kitchen appliance) can be switched on or off with a simple rotation of the connection part. Furthermore, by rotating the kitchen appliance, different voltages may be applied to the contact ring segments for generating different heating powers.

Preferably, at least two axially offset contacts may be provided in the inner side wall of the base part and at least two corresponding axially offset contacts may be provided at the height of at least two axially offset openings in the connection part, thereby ensuring that the two conductors required to connect a heating device in the kitchen appliance are protected against accidental and dangerous contact with the domestic power grid by an operator.

Accordingly, the axially offset contacts may be connected with a corresponding phase conductor and a corresponding neutral conductor of the domestic power grid, whereas a central protective contact, which need not be protected against accidental contact, may be connected in the connection part to a protective ground wire.

To allow the kitchen appliance to perform the aforementioned rotation on the connection part, the connection part, the recess in the base part and the cover element which is displaceable in the connection part have a substantially cylindrical shape, and the cover element can be moved in the connection part with a small clearance by way of a pin disposed in the recess against the force of a spring acting upon the transverse wall of the cover element.

For connecting a sensor arranged in the kitchen appliance, wherein the sensor, for example, switches off the power to the kitchen appliance when a predetermined temperature is reached, at least one contact may be arranged in the base part of the plug-in element and at least one corresponding radially elastically movable contact may be arranged on the connection part, which contact one another when the base part in the bottom of the kitchen appliance is placed onto the connection part, thereby displacing the cylindrical cover element. Although these contacts are not protected in the same manner to prevent accidental contact by a metal object, this contact does not pose any danger, because only a small, non-hazardous voltage is applied to the sensor or only a small voltage is generated.

In addition, a protective contact pin disposed in the recess in the base part may be connected with a protective ground conductor of the kitchen appliance and contact the central protective contact connected with ground wire in the connection part when the kitchen appliance is inserted, without requiring protection against accidental contact because generally no voltage is present at a ground conductor.

A secure, positive contact between the contacts in the connection part and the contacts in the base part may be established by forming the cover of an outer cylindrical member, which covers the at least one opening when the connection part is free of the kitchen appliance and which includes a coaxial, displaceable conical inner member, and by arranging compression springs between the connection part and the outer member as well as between the outer member and the conical inner member, wherein the spring constants of the compression springs are dimensioned such that, when the kitchen appliance is plugged onto the connection part, the outer member is moved first in an axial direction for unblocking the at least one contact, whereafter the conical inner member is moved in the axial direction for positive radial displacement of the at least one contact through the opening for contacting the at least one contact in the base part.

Another approach for establishing a positive contact includes arranging in the cylindrical cover element, starting from an upper transverse wall, a coaxial cylindrical extension with chamfers at a lower end face, wherein the chamfers cooperate with the contacts formed as contact leaves in the sense of pressing the contacts against the contact rings and against the protective contact pin when the base part in the bottom of the kitchen appliance is placed on the connection part.

An additional safeguard against accidental contact with the live contacts can be achieved by providing in the base part two parallel, radially spaced and diametrically opposed plug-in elements for displacing the cover element and by forming the cover element so that it can be displaced only when both plug-in elements operate on the cover element simultaneously and in parallel. This can be achieved, for example, in that the cover is tilted under a one-sided load and wedged in the connection part. In addition, the side walls of the connection part and the cover elements may have latching elements which cooperate when the cover element is tilted, thereby preventing displacement of the cover in an interlocking manner.

The invention will now be described with reference to several exemplary embodiments illustrated in the drawing. The drawing show in:

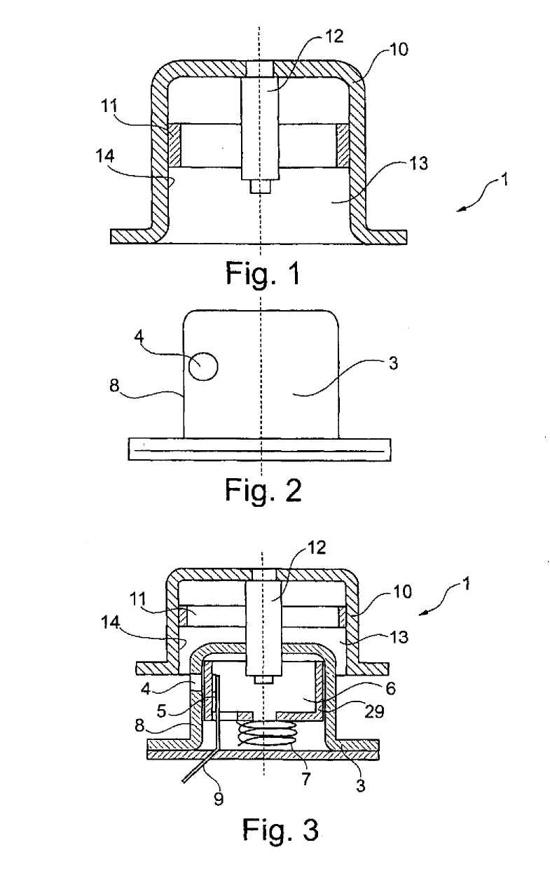

FIG. 1 a sectional view of a base part of the connection assembly according to the present invention,

FIG. 2: an external view of a connection part of the connection assembly according to the present invention,

FIG. 3 a sectional view of the connecting portion and the base part of the connection assembly according to the present invention when the kitchen appliance is initially placed on the connection part,

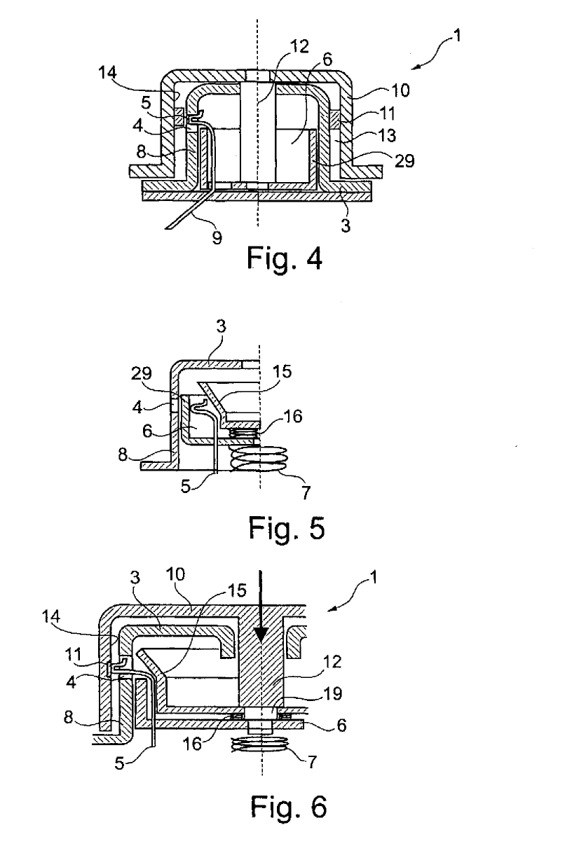

FIG. 4 the connection assembly according to the present invention when the kitchen appliance is placed completely on the connection part 3 with its base part,

FIG. 5 a partial cross-sectional view of a connection part according to a second embodiment,

FIG. 6 a sectional view of the second embodiment of the connection assembly according to the present invention in a position when the base part in the bottom of the kitchen appliance is placed on the connection part,

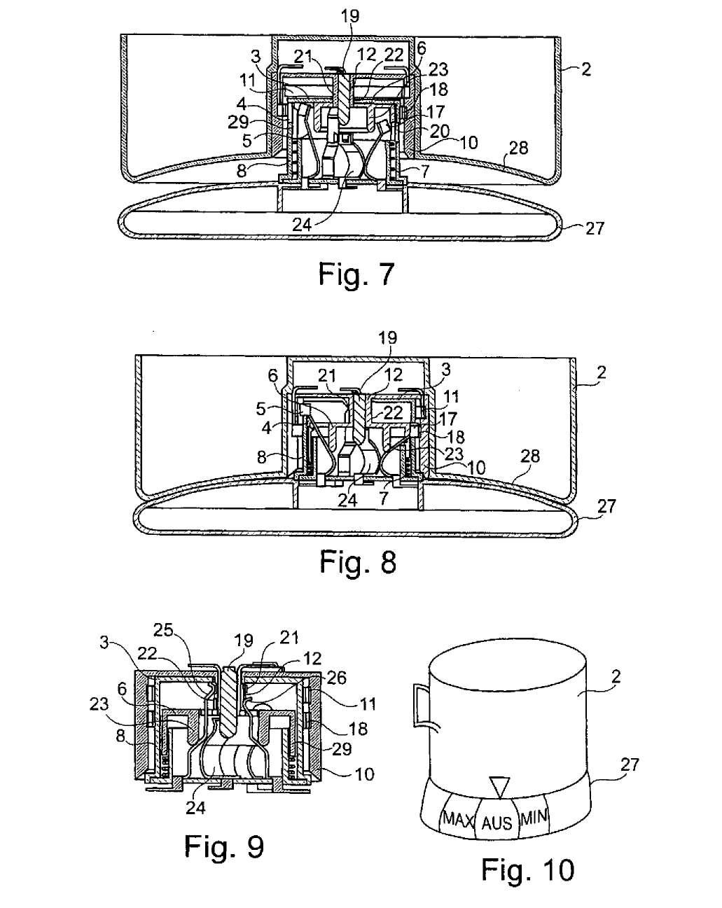

FIG. 7 a detailed diagram of the connection assembly according to the present invention corresponding shown in FIG. 3,

FIG. 8 a detailed diagram of the connection assembly according to the present invention in the position shown in FIG. 4,

FIG. 9 a sectional view of the connection assembly according to the present invention, which is rotated compared to the sectional view of FIG. 8, showing additional contacts for a sensor, and

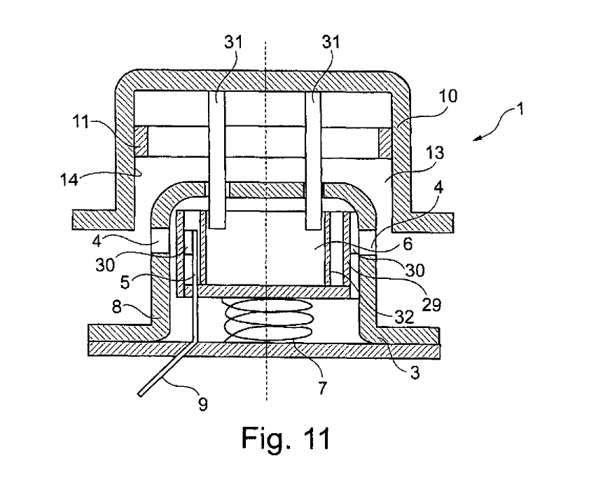

FIG. 10 a domestic appliance in form of a kettle which is placed on a base.

According to FIGS. 1 and 2, the connection assembly 1 according to the invention includes a connection part 3 in form of a projection which protrudes from a base 27 (FIGS. 7 and 8) and which has at least one opening 4 arranged in the outer side wall 8, as well as a base part 10 arranged in a bottom 28 (FIGS. 7 and 8) of a kitchen appliance 2. An electric contact 11 in form of a contact ring is disposed on or in an inner side wall 14, whereas a plug-in element 12 formed as a pin protrudes into a recess 13 of the base part 10.

A cover element 6 in the form of a cylindrical member with slight play is axially displaceable arranged in the connection part 3. This cover element 6 is moved by a spring 7 into the position illustrated in FIG. 3 as long as the plug-in element 12 is removed from the cover 6, as shown in FIG. 3. In this position, a side wall 29 of the cover element 6 closes at least one opening 4 in the outer side wall 8 of the connection part 3, preventing an electric contact 5 formed as a contact leaf, which can be connected to the domestic electrical system via a contact lug 9, from being deflected into the opening 4.

When the kitchen appliance 2 is placed with its base portion 10 completely onto the connection part 3, the cover element 6 is displaced so far downward by the plug member 12 that the opening 4 is exposed and the electric contact 5 can be deflected into the opening 4 to thereby establish contact with the ring-shaped electric contact 11. The resilient electric contact 5 and the ring-shaped contact 11 contact each other only in this position, whereas the opening 4 is closed in the position illustrated in FIGS. 1 to 3, thereby also preventing unintentional contact with the contact leaf 5 through the opening in the connection part 3 for the plug member 12.

The embodiment according to FIGS. 5 and 6 differs from the embodiment according to FIGS. 1 to 4 in that in addition to the outer cylindrical cover element 6 a coaxial, conical, inner member 15 is provided, with an additional compression spring 16 arranged between the conical member 15 and the cover element 6. The spring constants of the compression springs 7 and 16 are selected so that the plug-in element 12 first compresses the spring 7 below the cover element 6 when the base part 10 is installed, thereby unblocking the opening 4 in the connection part 3, whereafter the spring 16 is compressed, thereby moving the conical, inner member 15 toward the cover element 6. In this way, the conical inner member 15 causes a radial interlocking displacement of the electric contact 5 through the opening 4 against the ring-shaped contact 11, thereby ensuring a reliable electric contact between the contacts 5 and 11.

The plug-in element 12 is integrally formed with the base part 10 of a plastic material and has coaxially a protective contact pin 19 which, on one hand, is connected with a protective contact line in the kitchen appliance 2 and, on the other hand, contacts a protective contact in the base 27 of the domestic electrical grid.

The connection assembly 1 according to FIGS. 1 to 6 is adequate for a two-wire connection having phase and neutral conductors without a ground wire if it can be ensured that the protective contact in the base 27 can fundamentally only be connected to a neutral conductor of the domestic power grid, so that a phase can only be present at the electric contact 5.

Since the domestic electric power grids are typically equipped with a three-wire system having a phase conductor, a neutral conductor and a ground conductor, and since it cannot be guaranteed depending on the plug and socket design that the phase conductor is always connected to a predetermined contact 5, an embodiment shown in FIGS. 7 and 8 includes two electric contacts 5, 17 arranged in the connection part 3 and secured in the required manner against accidental and dangerous contact with the domestic power grid by an operator.

FIG. 7 shows a kitchen appliance 2 in form of a kettle, which has not yet been completely installed on the base 27. The cover element 6, which can be moved in the direction of the base 27 against the force of compression spring 7, is arranged in the connection part 3. In the illustrated position, the cover element 6 covers the opening 4 and a diametrically opposite and axially offset opening 20 in the connection part 3. The electric contact 5 and an additional diametrically opposed electric contact 17 rest against the side wall 29 of the cover element 6 and are thereby prevented from entering into the openings 4 and 20 and from contacting the ring-shaped electric contact 11 and another axially spaced ring-shaped electric contact 18. In the position shown in FIG. 7, the grounding contact pin 19 is still distal from a protective contact 24 arranged in the connection part 3.

A cylindrical extension 23 having an end face provided with circumferential chamfers is arranged coaxially with the cylindrical side wall 29 of the cover element 6. When the kitchen appliance 2 is moved into the position shown in FIG. 8 where the kitchen appliance 2 completely rests on the base 27, the plug-in element 12 displaces the cover element 6 into the illustrated position, exposing the openings 4 and 20 and allowing passage of the contacts 5, 17 for contacting the ring-shaped electric contacts 11 and 18 in the base part 10. An interlocking contact between the contacts 5, 17 and the ring-shaped contacts 11, 18 is effected by the cylindrical extension 23 which moves the electric contacts 5, 17 designed as contact leaves radially outward until they contact the ring-shaped electric contacts 11, 18.

In the position of the kitchen appliance 2 illustrated in FIG. 8, the ground contact pin 19 contacts a corresponding protective contact 24, which in principle cannot carry a hazardous voltage and therefore does not need to be protected against accidental contact.

In the exemplary embodiment shown in FIGS. 7 to 9, the plug-in element 12 has axially spaced ring-shaped contacts 21, 22, which cooperate in the position shown in FIG. 9 with axially offset contacts 25, 26 in the connection part 3. These ring-shaped contacts 21, 22 may be connected to a sensor in the kitchen appliance 2 in order to monitor the temperature of food items in the kitchen appliance 2. The signals from this unillustrated sensor are transmitted via the contacts 25, 26 in the connection part 3 to an unillustrated switching element which can serve as a temperature control device or as a disconnect device upon reaching a predetermined temperature. Such sensors and switches are well known and will therefore not be described in detail. Because in principle only small voltages are present at the contacts 21, 22, 25, 26 and there is no connection with the domestic power grid, these contacts need not be protected against accidental contact by an operator.

The contacts 25, 26 are constructed as contact leaves and are in the position shown in FIG. 9 formfittingly pressed inwardly by the cylindrical extension 23 against the ring-shaped contacts 21, 22.

FIG. 10 shows a kitchen appliance 2 which is mounted on the base 27. The kitchen appliance 2 has a marking shaped as an arrow near the bottom, whereas the base 27 has markings for the position OFF, the position MAX, i.e. maximum heat output, and MIN, i.e. minimum heat output.

By forming the ring-shaped contacts 11, 18 as segments and by applying different voltages to the segments via the contacts 5, 17 and via additional unillustrated angularly offset contacts, the kitchen appliance 2 can be switched off and different heating powers can be set by rotating the kitchen appliance 2 which causes the corresponding segments and contacts to contact each other. The heating powers need hereby not be limited to a minimum and a maximum setting, but intermediate values may also be possible with a suitable segmentation of the ring-shaped contacts 11, 18 and with a corresponding number of contacts contacting these segments.

To prevent a displacement of the cover element 6, 15 by external actions when kitchen appliance 2 is not installed, two parallel, radially spaced, and diametrically opposed coupling elements 31 of equal length, which are independent of the central pin 12, may be provided in the base part 10, which effect displacement of the cover elements 6, 15, whereas the central pin 12 is then only used for contacting the protective contact 24. When an attempt is made to displace the cover element 6, 15 by inserting a needle or a pin into one of the openings in the connection part 3 for the spaced plug-in elements 31, the cover element 6, 15 becomes wedged in the connection part 3 and is blocked through friction. An additional safeguard may be implemented by providing the side walls 8, 29 of the connection part 3 and of the cover element 6, 15 with latching elements 4, 30, which cooperate when off-center pressure is applied on the cover 6, 15, and prevent displacement of the cover 6, 15 in an interlocking manner. An insulating cylinder 32 arranged coaxially with side wall 39 of the cover element 6 prevents any contact with the contact 5 through the openings for the plug-in element pair 31 in the cover element 6.

1-13. (canceled)

14. A connection assembly for closing an electric contact, comprising:
a connection part having at least one closable opening and at least one first electric contact and a movable cover element configured to close the opening and to cover the at least one first contact,
and a base part connectable with the connection part and having at least one second electric contact,
wherein the cover element is arranged so that the at least one opening is unblocked when the connection part is connected with the base part, thereby conductively connecting the at least one first contact with the at least one second contact.

15. The connection assembly of claim 14, wherein the base part comprises a plug-in element engaging with the connection part, said plug-in element displacing the cover element when the connection part is connected with the base part.

16. The connection assembly of claim 14, wherein the at least one first contact is arranged in an area of the at least one opening and is radially resilient.

17. The connection assembly of claim 14, wherein the at least one second contact is disposed on or in an inner side wall of the base part and formed as a continuous or segmented contact ring disposed at a height of the at least one opening in the connection part.

18. The connection assembly of claim 17, wherein at least two axially spaced second contacts are disposed in the inner side wall of the base part and at least two corresponding axially spaced first contacts are disposed in the connection part at the height of at least two axially offset openings in the connection part.

19. The connection assembly of claim 18, wherein one of the two axially offset contacts is connected with a phase conductor and another of the two axially offset contacts is connected with a neutral conductor of the domestic power grid, and wherein a central contact in the connection part is connected to a ground conductor.

20. The connection assembly of claim 14, wherein the base part comprises a substantially cylindrical recess, wherein the connection part and the cover element are substantially cylindrical, and wherein the cover element is movable in the recess of the base part with slight play against a force of a spring acting on a transverse wall of the cover element by means of at least one pin.

21. The connection assembly of claim 15, further comprising at least one contact disposed on the plug-in element and at least one corresponding radially elastically movable contact disposed on the connection part, wherein the at least one contact disposed on the plug-in element and the at least one contact disposed on the connection part contact each other when the base part is placed on the connection part, thereby displacing the cover element.

22. The connection assembly of claim 20, wherein a ground contact pin in the recess in the base part is connected with a ground conductor of a kitchen appliance and contacts, when the kitchen appliance is placed onto the connection part, a central protective contact connected to a protective ground wire in the connection part.

23. The connection assembly of claim 14, wherein the cover element comprises an outer cylindrical member, which covers the at least one opening in absence of a kitchen appliance on the connection part, and further a coaxial, displaceable conical inner member, wherein the connection assembly further comprises compression springs arranged between the connection part and the outer cylindrical member as well as between the outer cylindrical member and the conical inner member, wherein spring constants of the compression springs are dimensioned such that when the kitchen appliance is placed onto the connection part, the outer cylindrical member is initially axially displaced to unblock the at least one first electric contact, whereafter the conical inner member is axially displaced through the opening and thus radially displaces the at least one first electric contact to enable contact with the at least one second electric contact in the base part.

24. The connection assembly of claim 20, wherein the cylindrical cover element comprises a coaxial cylindrical extension starting from an upper transverse wall and having a lower end face with chamfers cooperating with the at least one first contact formed as a contact leaf by pressing the at least one first contact against the at least one second contact embodied as a contact ring and against a ground contact pin, when the base part disposed in a bottom of a kitchen appliance is placed onto on the connection part.

25. The connection assembly of claim 14, wherein the base part comprises two parallel, radially spaced and diametrically opposed plug-in elements of equal length for displacing the cover element, and wherein the connection part has side walls which allow the cover element to be moved only when the two plug-in elements act on the cover element simultaneously and in parallel.

26. The connection assembly of claim 25, wherein the side walls of the connection part and side walls of the cover element have latching elements which cooperate when an off-center pressure is applied to the cover element and positively prevent displacement of the cover element.
